(19) United States
(12) Patent Application Publication
(10) Pub. No.: US 2019/0285878 A1
(43) Pub. Date: Sep. 19, 2019

(54) DISPLAY ASSEMBLY COMPONENT

(71) Applicant: Shanghai Yanfeng Jinqiao Automotive Trim Systems Co. Ltd., Novi, MI (US)

(72) Inventors: Scott Allen Hansen, Holland, MI (US); Karl R. Stanley, Holland, MI (US); James Bradley Price, Holland, MI (US); Mario Javier Enriquez Ortiz, Holland, MI (US); Rodney J. Tindall, Zeeland, MI (US)

(21) Appl. No.: 16/430,987

(22) Filed: Jun. 4, 2019

Related U.S. Application Data
(63) Continuation of application No. PCT/US2018/012612, filed on Jan. 5, 2018.
(60) Provisional application No. 62/443,348, filed on Jan. 6, 2017.

(51) Int. Cl. G02B 27/00

(52) U.S. Cl. CPC G02B 27/0018; B60K 35/00

(57) ABSTRACT

A component for a vehicle interior with a display panel is disclosed. The component may comprise a module comprising an insert and a cover. The cover and the insert may be configured to facilitate optical performance of the module. The insert may allow light to pass from the display panel to the cover and may limit reflection of light between the display panel and cover. An index of refraction of the insert may match an index of refraction of the cover. An outer surface of the insert may be contoured to align with a contoured surface of the cover. The insert may comprise a flat inner surface and a curved outer surface. The insert may be attached to the cover by an adhesive comprising an index of refraction between that of the cover and the insert. The cover may comprise glass and/or plastic.

### CROSS-REFERENCE TO RELATED APPLICATIONS

The present application is a continuation of International/PCT Patent Application No. PCT/US18/12612 titled “DISPLAY ASSEMBLY” filed Jan. 5, 2018, which claims the benefit of U.S. Provisional Patent Application No. 62/443,348 titled “DISPLAY ASSEMBLY” filed Jan. 6, 2017.

The present application claims priority to and incorporates by reference in full the following patent applications: (a) U.S. Provisional Patent Application No. 62/443,348 titled “DISPLAY ASSEMBLY” filed Jan. 6, 2017; (b) International/PCT Patent Application No. PCT/US18/12612 titled “DISPLAY ASSEMBLY” filed Jan. 5, 2018.

### FIELD

The present invention relates to a display assembly for a vehicle interior. The present invention also relates to display assembly comprising a display module for a vehicle interior. The present invention further relates to an arrangement for providing a display assembly in a vehicle interior.

### BACKGROUND

It is well known to provide a display panel or screen in a vehicle interior.

Display panels or screens in vehicle interiors are often covered with a cover that protects the display from damage. Display panels as screens are generally flat. Flat covers for a display are typically not desired by interior designers wishing to present contoured surfaces (e.g. in forms that are aesthetically integrated) typically considered more pleasing to vehicle occupants.

When providing flat displays or screens behind a curved surface of a clear cover a gap (e.g. air gap or space) is formed between the flat surface of the display/screen and the curved interior surface of the cover. The gap may permit reflections (e.g. reflections of ambient light and light from the display panel) that are detrimental to the visible image quality on the cover from the display. The existence of the gap may present an undesirable appearance of the display screen when the display/screen is turned off (e.g. “dead front” or “black panel” appearance is desired instead of an air gap giving an undesired appearance that there is no screen present when the display is turned off). The existence of the gap may present an appearance of the display with reduced brightness and/or contrast. It is generally desirable that the display/screen for a display assembly in a vehicle interior only become visible when the display is turned on.

It would be advantageous to provide an improved display assembly for a vehicle interior. It would also be advantageous to provide an improved arrangement for providing a display assembly in a vehicle interior. It would further be advantageous to provide an improved display assembly with a contoured surface and improved visual appearance when the display/screen is off and/or when the display/screen is on (in use with the image display).

### SUMMARY

The present invention relates to a component for an interior of a vehicle with a display panel configured to provide a display providing light intended to be visible to an occupant in the vehicle when in operation after installation in the interior of the vehicle comprising a cover comprising an outer surface and an insert configured to be positioned between the display panel and the cover. The insert may be configured to allow light to pass from the display to the cover. The cover may comprise a material and may provide an index of refraction. The insert may comprise a material and may provide an index of refraction. The material of the insert may be selected so that the index of refraction of the material of the insert substantially matches the index of refraction of the material of the cover. The cover and the insert may comprise a module. The cover and the insert may be configured to facilitate optical performance of the module. The insert may be configured to limit reflection of light between the display panel and the cover. The cover may comprise an inner surface and the outer surface; the insert may comprise an inner surface and an outer surface; the outer surface of the insert may be configured to align with the inner surface of the cover. The cover may comprise an inner surface and the outer surface; the insert may comprise an inner surface and an outer surface; the inner surface of the cover and the outer surface of the insert may be contoured. The display panel may comprise a generally flat surface; the inner surface of the insert may be generally flat and the outer surface of the insert may be curved; the inner surface of the cover may be curved and the outer surface of the cover may be curved. The material of the cover may comprise at least one of (a) a urethane material; (b) an acrylic material; (c) a polycarbonate material; (d) a substantially transparent material; (e) a plastic material; (f) a resin material; (g) a glass material; (h) glass; (i) a nylon material; (j) a co-polyester material; (k) a cellulose acetate material; (l) a PET material; (m) a poly-acrylic material; (n) a polymer material. The material of the insert may comprise at least one of (a) a urethane material; (b) an acrylic material; (c) a polycarbonate material; (d) a substantially transparent material; (e) a plastic material; (f) a resin material; (g) a glass material; (h) glass; (i) a nylon material; (j) a co-polyester material; (k) a cellulose acetate material; (l) a PET material; (m) a poly-acrylic material; (n) a polymer material. The index of refraction of the cover may be between about 1.3 and about 1.6; the index of refraction of the insert may be between about 1.3 and about 1.6. The insert may be attached to the cover by an adhesive; the adhesive may comprise an index of refraction between an index of refraction for the material of the cover and an index of refraction for the material of the insert. The material of the cover may comprise at least one of (a) glass and/or (b) plastic. The component may further comprise an interface between the cover and the display panel; the interface may comprise at least one of (a) a sensor; (b) a touch-screen interface; (c) a sensor grid; (d) a touch screen grid.

The present invention relates to a display assembly for an interior of a vehicle comprising a cover comprising an inner surface and an outer surface, an insert comprising an inner surface and an outer surface, and a display panel configured to provide a display providing light. The inner surface of the cover may be coupled to the outer surface of the insert. The inner surface of the insert may be coupled to the display panel. The cover may comprise a material providing an index of refraction. The insert may comprise a material providing an index of refraction and may be configured to allow light from the display to transmit from the display panel to the cover. The outer surface of the cover may comprise a contoured surface. The inner surface of the cover and the outer surface of the insert may be configured to align. The index of refraction of the material of the insert may be substantially equivalent to the index of refraction of the material of the cover. The display assembly may further comprise an adhesive configured to attach the insert to the cover; the adhesive may comprise a material providing an index of refraction substantially equivalent to at least one of (a) the index of refraction of the material of the insert; (b) the index of refraction of the material of the cover. The adhesive may comprise a material selected to provide an index of refraction substantially equivalent to the index of refraction of the material of the insert and the index of refraction of the material of the cover. The adhesive may comprise at least one of (a) a PET material; (b) a PMMA material; (c) a polycarbonate material; (d) a polymer blend material; (e) a polycarbonate/PMMA blend; (f) a poly-acrylic material; (g) a film; (h) an optically clear adhesive. The display panel may comprise a flat surface.

The present invention relates to a module for an interior of a vehicle with a display panel configured to provide a display providing light intended to be visible to an occupant in the vehicle when the display panel is in operation in the interior of the vehicle comprising a cover comprising a contoured outer surface, an insert between the display panel and the cover, and an adhesive layer provided to bond the cover to the insert. The cover may comprise a material providing an index of refraction. The insert may comprise a material providing an index of refraction. The adhesive layer provided to bond the cover to the insert may comprise a material providing an index of refraction. The index of refraction of the material of the cover may be substantially equivalent to the index of refraction of the material of the insert. The adhesive may comprise at least one of (a) an optically clear adhesive; (b) an adhesive blend; (c) a silicone-based adhesive; (d) a blend with an optically clear adhesive; (e) a liquid optically clear adhesive; (f) an applied adhesive; (g) a film adhesive; (h) a pressure-sensitive adhesive; (i) a pressure-sensitive adhesive film. The index of refraction of the material of the adhesive layer between the cover and the insert may be substantially between the index of refraction of the material of the cover and the index of refraction of the material of the insert. The module may further comprise at least one of (a) a coating on an inner surface of the cover providing an index of refraction substantially between the index of refraction of the material of the insert and the index of refraction of the material of the cover; (b) a coating on an outer surface of the insert providing an index of refraction substantially between the index of refraction of the material of the insert and the index of refraction of the material of the cover; (c) a coating on an inner surface of the cover providing an index of refraction substantially equivalent to the index of refraction of the insert; (d) a coating on an outer surface of the insert providing an index of refraction substantially equivalent to the index of refraction of the cover. The index of refraction of the material of the cover may be between about 1.3 and about 1.6; the index of refraction of the material of the insert may be between about 1.3 and about 1.6; the index of refraction of the material of the adhesive layer may be between about 1.4 and about 1.7.

The present invention relates to a component for an interior of a vehicle with a display panel configured to provide a display providing light intended to be visible to an occupant in the vehicle when in operation after installation in the interior of the vehicle. The component may comprise (a) a cover comprising an outer surface; (b) an insert configured to be positioned between the display panel and the cover. The insert may be configured to allow light to pass from the display to the cover; the cover may comprise a material and provides an index of refraction; the insert may comprise a material and provides an index of refraction.

The index of refraction of the cover may be substantially equivalent to the index of refraction of the insert. The index of refraction of the cover may be within about 25 percent of the index of refraction of the insert. The index of refraction of the cover may be between about 1.3 and about 1.6; and the index of refraction of the insert may be between about 1.3 and about 1.6. The material of the insert may be selected so that the index of refraction of the material of the insert substantially matches the index of refraction of the material of the cover.

The cover and the insert may comprise a module; the cover and the insert may be configured to facilitate optical performance of the module. The insert may be configured to limit reflection of light between the display panel and the cover. The cover may comprise an inner surface and the outer surface; the insert may comprise an inner surface and an outer surface; and the outer surface of the insert may be configured to align with the inner surface of the cover. The cover may comprise an inner surface and the outer surface; the insert may comprise an inner surface and an outer surface; and the inner surface of the cover and the outer surface of the insert may be contoured. The display panel may comprise a generally flat surface; the inner surface of the insert may be generally flat and the outer surface of the insert may be curved; the inner surface of the cover may be curved and the outer surface of the cover may be curved.

The material of the cover may comprise at least one of (a) a urethane material; (b) an acrylic material; (c) a polycarbonate material; (d) a substantially transparent material; (e) a plastic material; (f) a resin material; (g) a glass material; (h) glass; (i) a nylon material; (j) a co-polyester material; (k) a cellulose acetate material; (l) a PET material; (m) a poly-acrylic material; (n) a polymer material. The material of the insert may comprise at least one of (a) a urethane material; (b) an acrylic material; (c) a polycarbonate material; (d) a substantially transparent material; (e) a plastic material; (f) a resin material; (g) a glass material; (h) glass; (i) a nylon material; (j) a co-polyester material; (k) a cellulose acetate material; (l) a PET material; (m) a poly-acrylic material; (n) a polymer material. The material of the cover may be substantially the same as the material of the insert. The material of the insert may comprise an index of refraction of between about 1.3 and about 1.6. The material of the cover may comprise an index of refraction of between about 1.3 and about 1.6.

The component may comprise an adhesive configured to attach the insert to at least one of (a) the cover or (b) the display panel. The adhesive may comprise at least one of (a) an optically clear adhesive; (b) an adhesive blend; (c) a silicone-based adhesive; (d) a blend with an optically clear adhesive; (e) a liquid optically clear adhesive; (f) an applied adhesive; (g) a film adhesive; (h) a pressure-sensitive adhesive; (i) a pressure-sensitive adhesive film. The adhesive may comprise a film comprising at least one of (a) a PET material; (b) a PMMA material; (c) a polycarbonate material; (d) a polymer blend material; (e) a polycarbonate/PMMA blend; (f) a poly-acrylic material. The adhesive may comprise a material; the material of the adhesive may comprise an index of refraction of between about 1.4 and about 1.7. The adhesive may comprise an index of refraction substantially equivalent to at least one of (a) the index of refraction for the material of the cover; (b) the index of refraction for the material of the insert. The adhesive may comprise an index of refraction between the index of refraction for the material of the cover and the index of refraction for the material of the insert. The adhesive may comprise a blended material. The insert may be attached to the cover by an adhesive; and the insert may be attached to the display panel by an adhesive. The insert may be attached to the cover by an adhesive on a film.

The outer surface of the cover may comprise a contour shape; the material of the cover may comprise at least one of (a) glass or (b) plastic. The component of Claim 1 further comprising an interface between the cover and the display panel; the interface may comprise at least one of (a) a sensor; (b) a touch-screen interface; (c) a sensor grid; (d) a touch screen grid.

The present invention relates to a display assembly for an interior of a vehicle comprising: (a) a cover comprising an inner surface and an outer surface; (b) an insert comprising an inner surface and an outer surface; (c) a display panel configured to provide a display providing light; the inner surface of the cover may be coupled to the outer surface of the insert; the inner surface of the insert may be coupled to the display panel; the cover may comprise a material providing an index of refraction; the insert may comprise a material providing an index of refraction and may be configured to allow light from the display to transmit from the display panel to the cover.

The outer surface of the cover may comprise a contoured surface; the inner surface of the cover and outer surface of the insert may be configured to align. The display panel may comprise a flat surface; the outer surface of the cover may comprise a contour. The index of refraction of the insert may be substantially equivalent to the index of refraction of the cover.

The display assembly may comprise an adhesive configured to attach the insert to the cover. The adhesive may comprise a material providing an index of refraction substantially equivalent to at least one of (a) the index of refraction of the insert; (b) the index of refraction of the cover. The adhesive may comprise an index of refraction between the index of refraction for the material of the cover and the index of refraction for the material of the insert. The adhesive may comprise a material selected or blended to provide an index of refraction substantially equivalent to the index of refraction of the insert and the index of refraction of the cover. The display assembly may comprise an interface between the cover and the display panel; the interface may comprise at least one of (a) a sensor; (b) a touch-screen interface; (c) a sensor grid; (d) a touch screen grid.

The present invention relates to a module for an interior of a vehicle with a display panel configured to provide a display providing light intended to be visible to an occupant in the vehicle when the display panel may be in operation in the interior of the vehicle. The module may comprise (a) a cover comprising a contoured outer surface; (b) an insert between the display panel and the cover; (c) an adhesive layer provided to bond the cover to the insert with no air gap; the cover may comprise a material providing an index of refraction; the insert may comprise a material providing an index of refraction; the adhesive layer provided to bond the cover to the insert may comprise a material providing an index of refraction. The module may comprise the display panel to form a display module.

The index of refraction of the cover may be substantially equivalent to the index of refraction of the insert. The material of the cover may be substantially identical to the material of the insert. The index of refraction of the adhesive layer between the cover and the insert may be substantially between the index of refraction of the cover and the index of refraction of the insert. The index of refraction of the adhesive layer between the cover and the insert may be substantially equivalent to at least one of (a) the index of refraction of the insert or (b) the index of refraction of the cover. The index of refraction of the cover may be substantially equivalent to the index of refraction of the insert. The index of refraction of the material of the insert may be between about 1.3 and about 1.6. The index of refraction of the material of the cover may be between about 1.3 and about 1.6. The index of refraction of the material of the adhesive layer may be between about 1.4 and about 1.7. The material of the adhesive layer may be selected or blended to provide the index of refraction of the adhesive layer. The module may comprise an adhesive layer between the insert and the display panel. The adhesive layer between the insert and the display panel may comprise a material providing an index of refraction; the index of refraction of the adhesive layer between the insert and the display panel may be substantially equivalent to the index of refraction of the insert.

The module may comprise at least one of (a) a coating on an inner surface of the cover providing an index of refraction substantially between the index of refraction of the insert and the index of refraction of the cover; (b) a coating on an outer surface of the insert providing an index of refraction substantially between the index of refraction of the insert and the index of refraction of the cover. The module may comprise at least one of (a) a coating on an inner surface of the cover providing an index of refraction substantially equivalent to the index of refraction of the insert; (b) a coating on an outer surface of the insert providing an index of refraction substantially equivalent to the index of refraction of the cover.

### FIGURES

FIGS. 1A and 1B are schematic perspective views of a vehicle according to an exemplary embodiment.

FIG. 1C is a schematic perspective view of a vehicle interior providing a display module according to an exemplary embodiment.

FIGS. 1D and 1E are schematic diagrams of a display panel for a display assembly according to an exemplary embodiment.

FIG. 2A is a schematic perspective view of a display assembly for a vehicle interior according to an exemplary embodiment.

FIG. 2B is a schematic perspective cut-away view of a display assembly for a vehicle interior according to an exemplary embodiment.

FIG. 2C is a schematic perspective cut-away view of a display assembly for a vehicle interior according to an exemplary embodiment.

FIGS. 3A to 3D are schematic diagrams of a display panel for a display assembly according to an exemplary embodiment.

FIGS. 4A to 4F are schematic diagrams of a display panel for a display assembly according to an exemplary embodiment.

FIG. 5 is a schematic cross-section view of a display assembly with an air gap according to an exemplary embodiment.

FIG. 6A is a schematic exploded cross-section view of a display assembly with a filler/insert according to an exemplary embodiment.

FIG. 6B is a schematic cross-section view of a display assembly with a filler/insert according to an exemplary embodiment.

FIGS. 6C and 6D are a schematic exploded cross-section views of a display assembly with a filler/insert according to an exemplary embodiment.

FIG. 7A is a schematic exploded cross-section view of a display assembly with a filler/insert according to an exemplary embodiment.

FIG. 7B is a schematic cross-section view of a display assembly with a filler/insert according to an exemplary embodiment.

FIGS. 8A and 8C are schematic cross-section views of optical performance of a display assembly according to an exemplary embodiment.

FIG. 8B is a schematic cross-section view of optical performance of a display assembly with an air gap according to an exemplary embodiment.

FIGS. 9A and 9C are schematic cross-section views of optical performance of a display assembly according to an exemplary embodiment.

FIG. 9B is a schematic cross-section view of optical performance of a display assembly with an air gap according to an exemplary embodiment.

FIGS. 10A to 10C are schematic cross-section views of optical performance of a display assembly with an air gap according to an exemplary embodiment.

FIGS. 11A to 11C are schematic cross-section views of optical performance of a display assembly according to an exemplary embodiment.

FIG. 12A is a schematic cross-section view of optical performance of a display assembly according to an exemplary embodiment.

FIG. 12B is a schematic cross-section view of optical performance of a display assembly with an air gap according to an exemplary embodiment.

FIGS. 13A to 13C are schematic cross-section views a display assembly/module according to an exemplary embodiment.

FIGS. 14A to 14J are schematic diagrams of a method of construction/assembly of a display assembly/module according to an exemplary embodiment.

FIGS. 15A to 15C are schematic flow diagrams of a method of construction/assembly of a display assembly/module according to an exemplary embodiment.

### DESCRIPTION

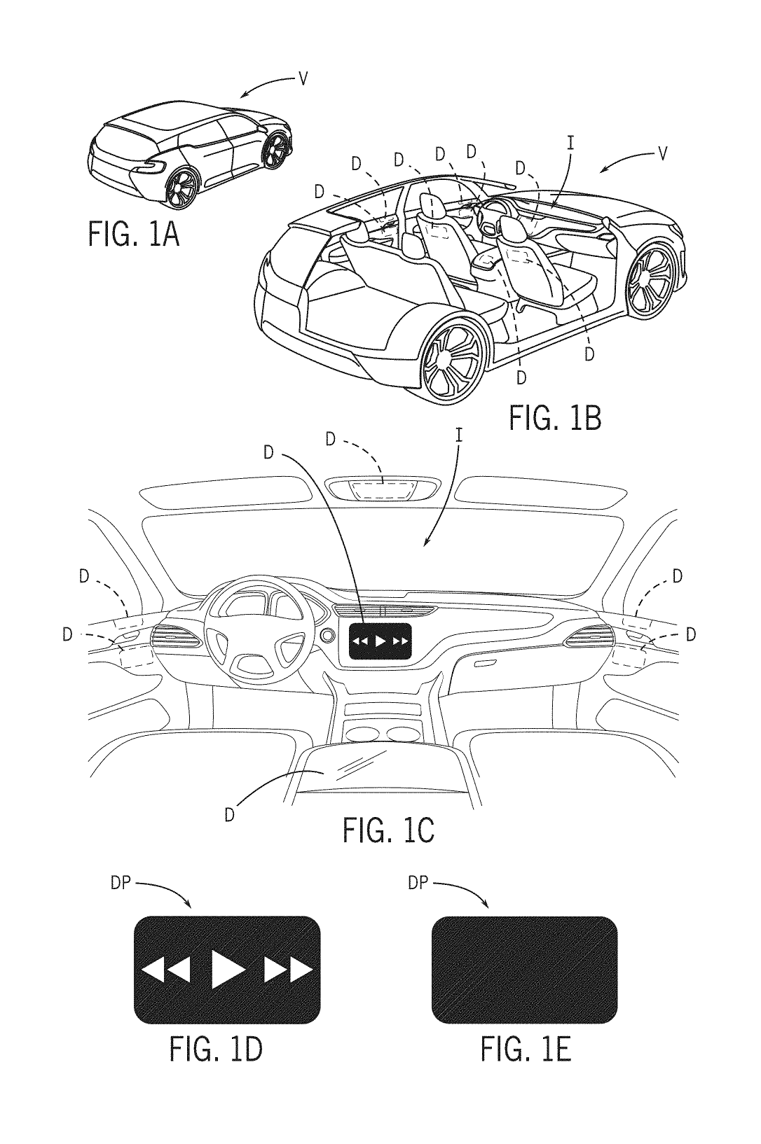

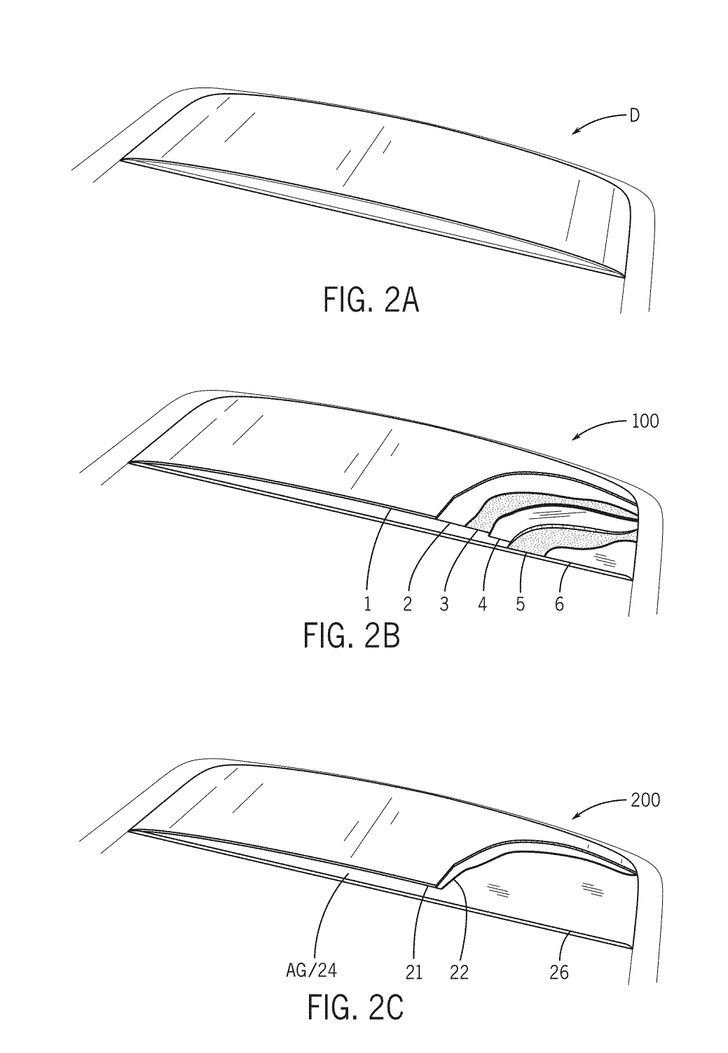

Referring to FIGS. 1A and 1B, a vehicle V with a vehicle interior I is shown schematically according to an exemplary embodiment. The vehicle interior provides various components such as panels, consoles, compartments, etc. that may provide a display assembly/module D (e.g. with display panel, display screen, display device, illumination device, data display, etc.) to present information, alerts, entertainment, data, etc. to a vehicle occupant (e.g. data/information as may be available from various sources). As indicated schematically according to an exemplary embodiment the vehicle interior I may be provided with a variety of display/display module D configurations in a variety of positions and locations to serve a variety of purposes. See e.g. FIGS. 1B and 2A-2B.

According to an exemplary embodiment, the display configuration/assembly D may be integrated physically and aesthetically into the vehicle interior I (e.g. with the design/form and configuration of other vehicle interior components such as panels and console assemblies). As shown schematically according to an exemplary embodiment, integration may be facilitated by providing the display assembly/module D with a form and shape that fits/conforms to the shape/surface of the component providing the display assembly. See e.g. FIGS. 1B and 2A-2B.

As indicated schematically in FIGS. 1B, 1C and 2A according to an exemplary embodiment, the display assembly/module D may be integrated with a floor console, instrument panel, door/door panel, center console, overhead console, post/pillar, seat, control, audio/data system, instrumentation, etc. (As shown schematically in FIG. 1D-1E, data/information is intended to be made visible on the display module.) As shown schematically in FIGS. 1C and 2A, the display assembly/module D may provide a shaped/curved exterior surface (e.g. for integration with the vehicle interior aesthetic for functional/visual purposes, etc.).

As indicated schematically according to an exemplary in FIGS. 1B and 1C, the interior I of the vehicle may be provided with at least one display module D (e.g. one display module or multiple display modules in one or multiple locations) configured to provide a data/information display for the operator and/or occupants of the vehicle. As indicated according to an exemplary embodiment in FIGS. 1B-1C and 1D-1E, a display module 100/D may comprise a display panel DP (e.g. integrated display device/screen) configured to present a type or variety of data/information (including but not limited to text, graphics, instructions, user interface, instrumentation, communications, system information, status, controls/buttons, etc.) provided by a display/computing system that may be connected to one or more vehicle systems or other data/computing systems and/or networks. See also FIG. 2B. According to an exemplary embodiment as indicated schematically in FIGS. 1B-1E, the display panel D/DP may comprise a generally flat display screen configured to display data/information selectively when “on” (with illuminated pixels, see FIG. 1D) or to remain “off” with no data/information display (with no illuminated pixels, see FIG. 1E). See also FIG. 2B.

As indicated schematically according to an exemplary embodiment in FIG. 2A, the display module D may be provided in a curved form with a cover providing an exterior surface (e.g. visible exterior surface that may provide a user interface such as a touch surface); as indicated schematically according to an exemplary embodiment, the display module D may comprise a curved cover/assembly and a flat panel display screen DP. See FIGS. 1C and 1D-1E.

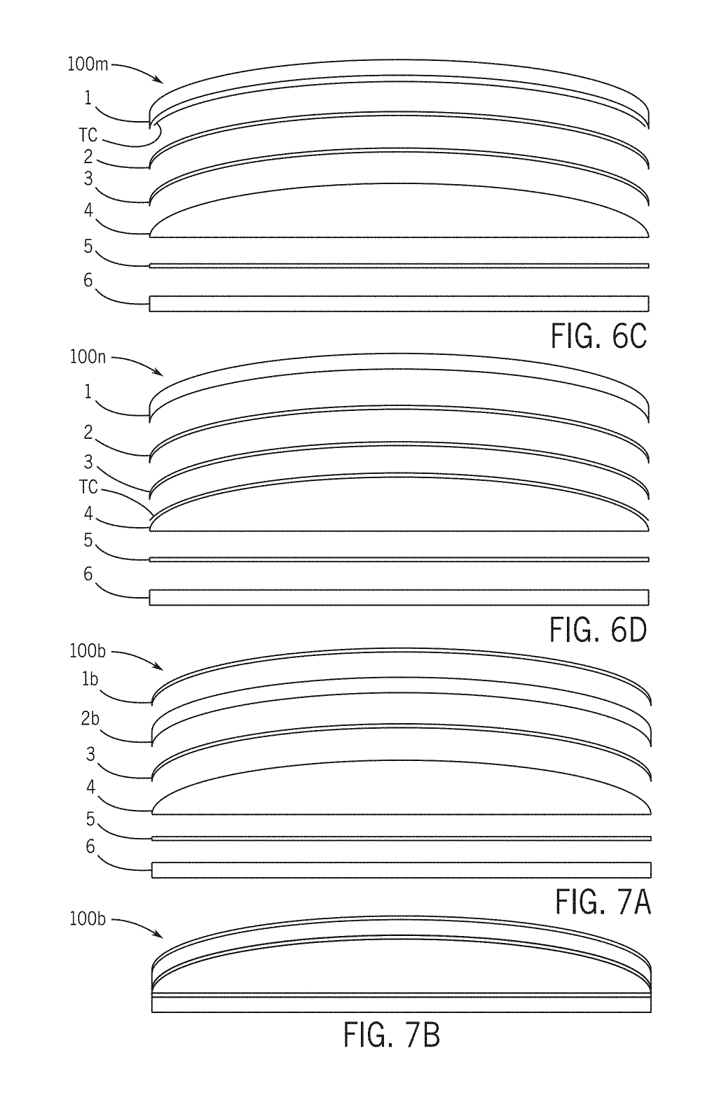

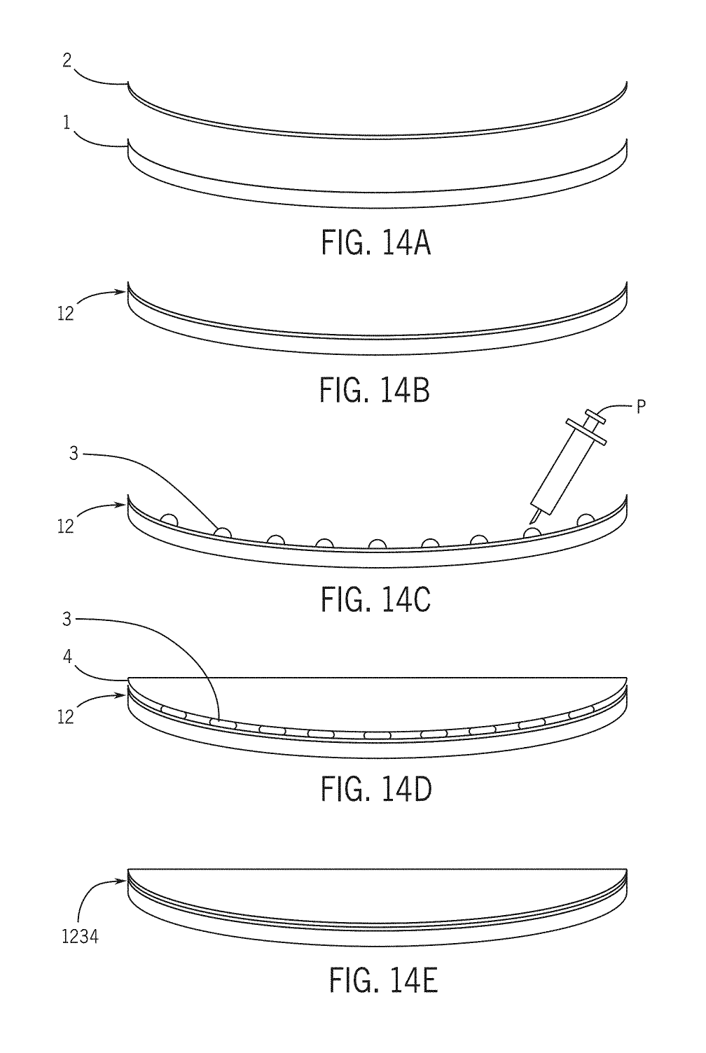

Referring to FIG. 2B, a display module 100 is shown schematically according to an exemplary embodiment to comprise a multi-layer construction (e.g. bonded construction) providing a cover 1 (e.g. exterior surface shown as a curved form) and an interface layer 2 (e.g. touch screen, capacitive sheet/film, etc. under the cover) and an adhesive/bond layer 3 (e.g. a liquid optically clear adhesive, adhesive blend, adhesive film/sheet, etc.) and a filler/insert 4 (e.g. insert material/form selected to provide optical characteristics) and an adhesive/bond layer 5 (e.g. a liquid optically clear adhesive, adhesive blend, adhesive film/sheet, etc.) and a display panel 6 (e.g. selectively illuminated display). See also FIGS. 6A-6B, 7A-7B, 14A-14J and 15A-15C (example forming process/method). As indicated schematically according to an exemplary embodiment in FIGS. 2A-2B, the display module 100 may be constructed with a designated thickness and designated form or shape comprising a curve or contour (e.g. to provide a generally aesthetic appearance). As indicated schematically according to an exemplary embodiment in FIGS. 13A-13C, the display module with cover assembly 1/2/3 and filler/insert 4 and display panel/adhesive assembly 5/6 may be provided in a variety of constructions and forms/configurations; as indicated schematically in FIG. 13A, display module 100r may comprise a curvature with an effective radius Ra and thickness Ta for the filler/insert 4; as indicated schematically in FIG. 13B, display module 100s may comprise a curvature with an effective radius Rb and thickness Tb for the filler/insert 4; as indicated schematically in FIG. 13C, display module 100t may comprise a curvature with an effective radius Rc and thickness Tc for the filler/insert 4. See also FIGS. 2A-2B (e.g. curved/form construction for display module).

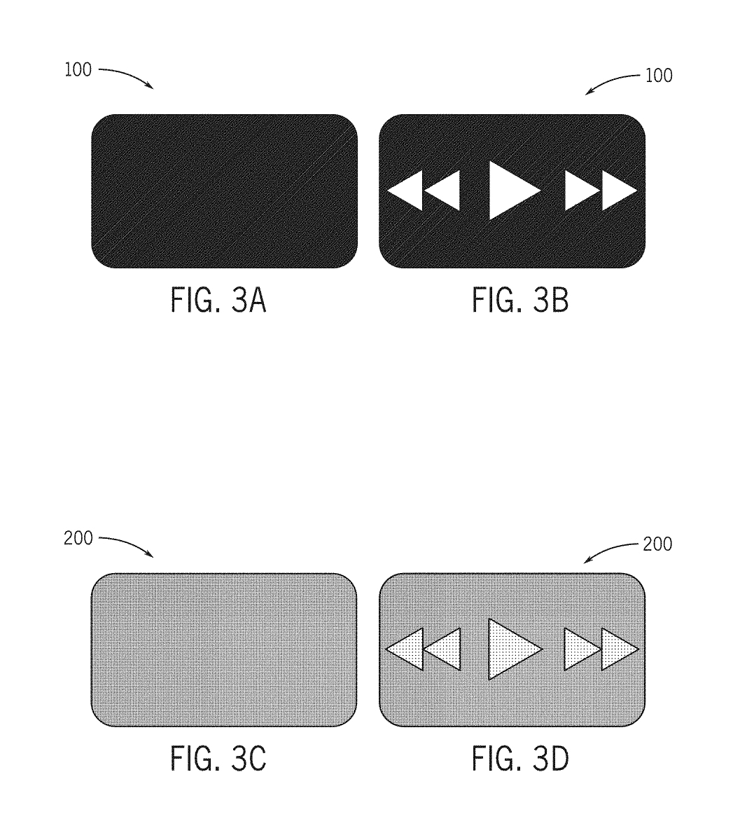

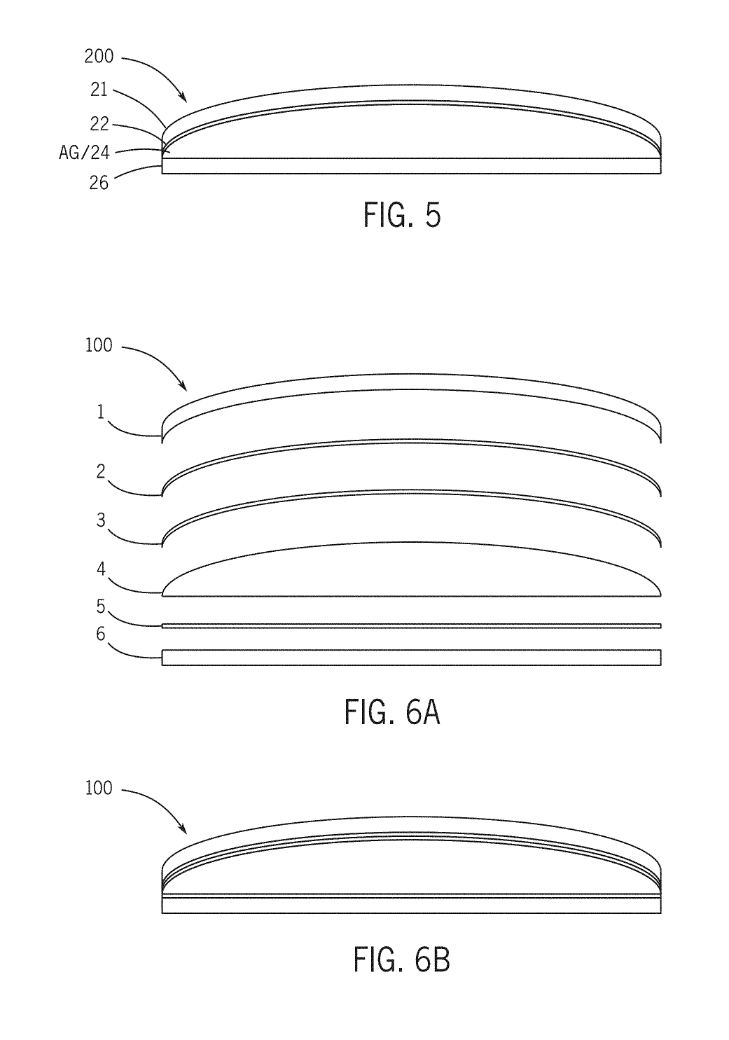

Referring to FIG. 2C, a display module 200 is shown schematically to comprise a cover 21 with interface layer 22 and an open space/air gap AG/24 above a display panel 26. See also FIGS. 3C-3D and 5.

As indicated schematically according to an exemplary embodiment in FIGS. 3A-3D, the selection of materials and construction/form may facilitate an intended relative preservation/improvement of optical performance/characteristics of the display module (e.g. contrast, dynamic range, brightness/intensity, transmittance, distortion, lens effects, reflective effects, refraction effects, light pollution effects, stray light effects, overall image quality, etc.). See also FIGS. 1D-1E and 4A-4F, 8A-8C, 9A-9C, 10A-10C, 11A-11C and 12A-12C.

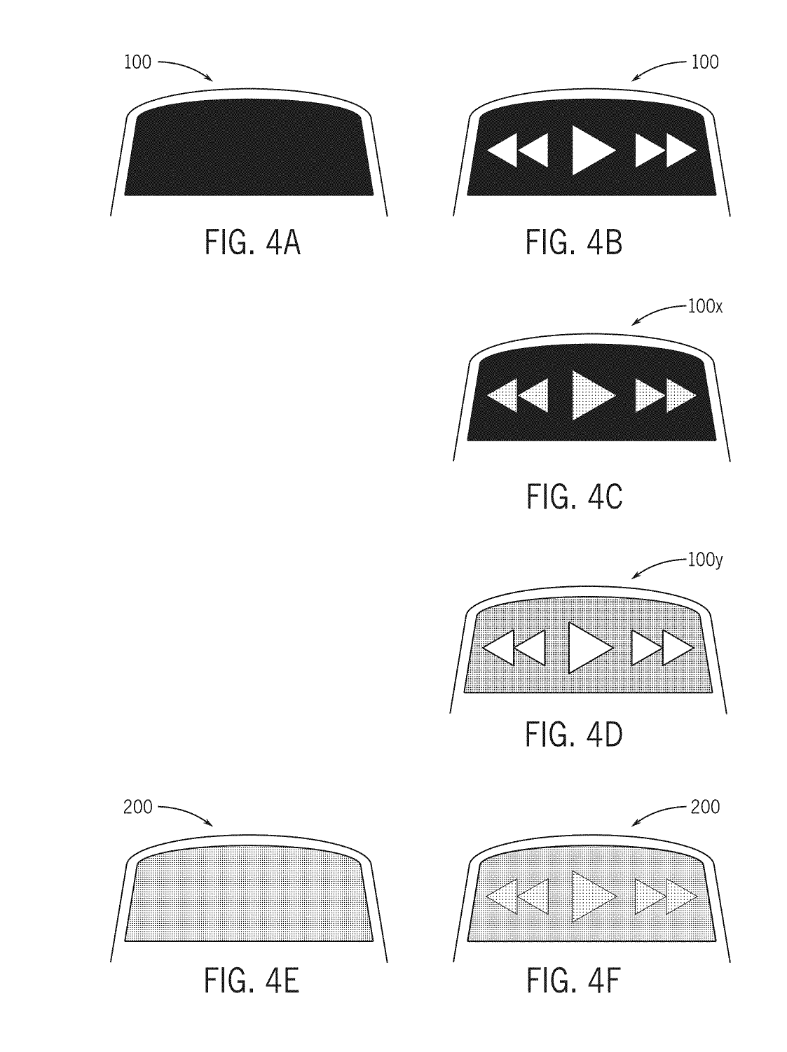

As indicated schematically in FIGS. 3A-3B and 4A-4B, the display module 100 (e.g. with filler/insert) may provide an “off” state in which there is in effect no visible light (e.g. a readily apparent and generally aesthetically appealing virtually completely “black” indication of the “off” state) and an “on” state with information display in which a high range of illumination and contrast is provided (e.g. as to facilitate visibility/clarity and ease of perception of information displayed in the “on” state).

As indicated in FIGS. 3C-3D and 4E-4F, the display module 200 (e.g. with air gap) may provide an “off” state in which there is visible light (e.g. light pollution for example due to reflection effects of ambient light within the air gap of the module producing a “gray” effect in the “off” state) and an “on” state with information display in which contrast is reduced (e.g. intensity of light is reduced due to reflection effects of light from the display and ambient light within the air gap such as will produce a “gray” effect in the “on” state).

As indicated in FIG. 4A to 4C, the display module 100 (e.g. with filler/insert) may be constructed to provide an “off” state in which there is relatively little visible light (e.g. relatively little light pollution for example due to reflection effects of ambient light within the filler/insert of the module producing a substantially “black” effect in the “off” state) and an “on” state with information display in which contrast is generally high (e.g. intensity of light is reduced only slightly due to reflection effects of light from the display and ambient light within the filler/insert such as will produce only a slight “gray” effect in the “on” state).

As indicated in FIG. 4D, the display module 100y (e.g. with filler/insert) may be constructed to provide an “off” state in which there is some notable degree of visible light (e.g. some light pollution for example due to reflection effects of ambient light within the filler/insert of the module producing a “gray-black” effect in the “off” state) and an “on” state with information display in which contrast is slightly reduced (e.g. intensity of light is reduced due to reflection effects of light from the display and ambient light within the filler/insert such as will produce a slight “gray” effect in the “on” state).

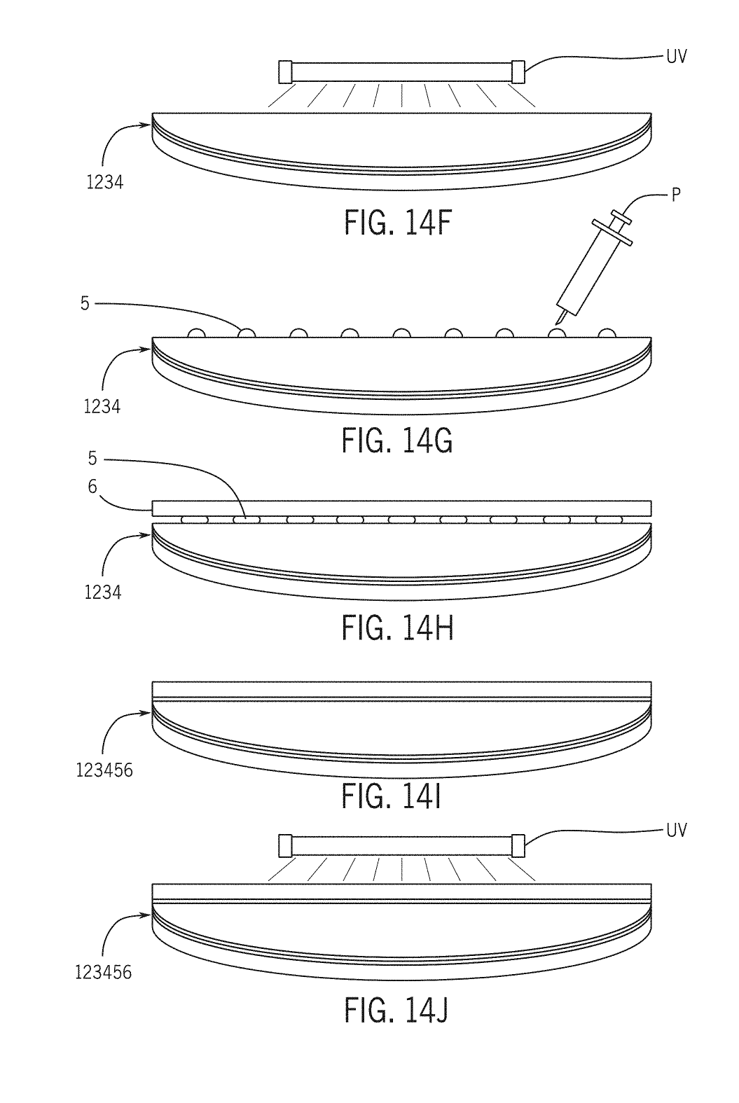

As indicated schematically in FIGS. 1D-1E, 2A, 3A-3C and 4A-4F, the construction of the display module D/100 with a filler/insert 4 (see FIGS. 2B, 3A-3B and 6A-6B) and with selection of suitable materials may provide improved optical performance/characteristics in comparison to the display module 200 with air gap AG/24 (see FIGS. 2C, 3C-3D and 5). Referring to FIGS. 6A-6B, according to an exemplary embodiment shown schematically the display module 100 comprises a multi-layer construction in which adhesive/bond layers 3 and 5 may comprise an adhesive film or sheet. See also FIGS. 1D-1E, 2A-2B and 4A-4B. Referring to FIGS. 14A-14J, according to an exemplary embodiment shown schematically the display module 123456 comprises a multi-layer construction in which adhesive/bond layers 3 and 5 may comprise an adhesive material applied as a fluid (e.g. spray, liquid such as applied by applicator P, etc.). See also FIGS. 1D-1E, 2A-2B and 4A-4B.

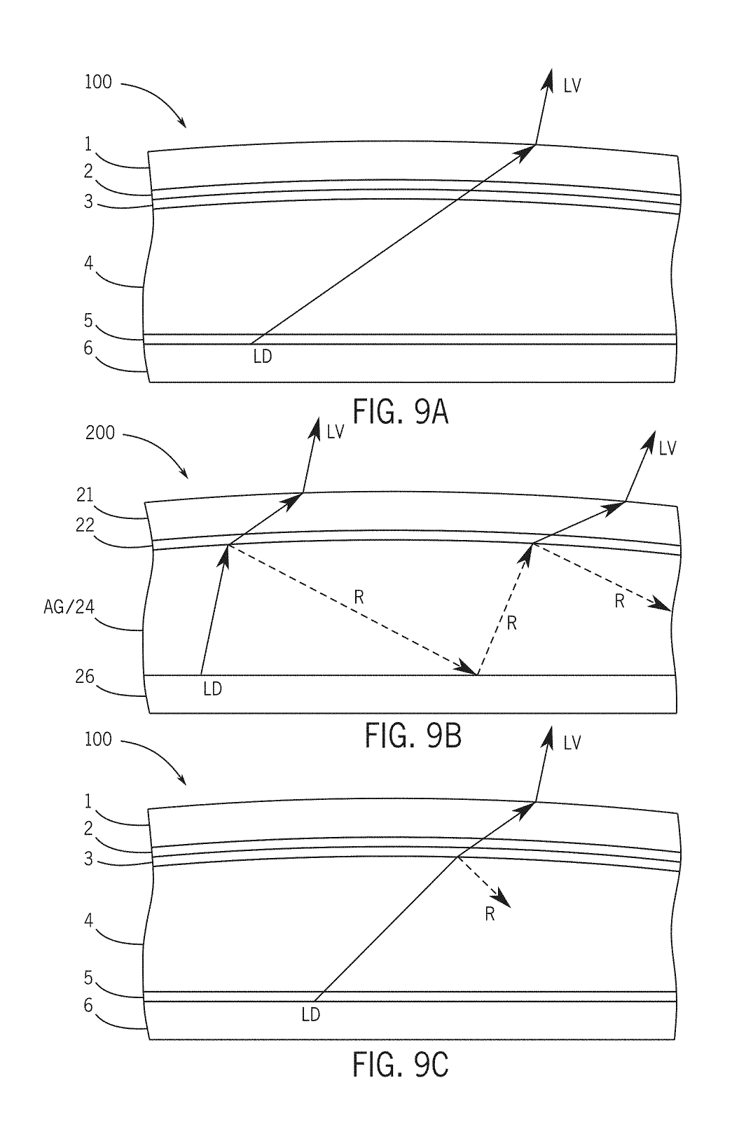

According to an exemplary embodiment as indicated schematically in FIGS. 8A-8C, 9A-9C, 10A-10C, 11A-11C and 12A-12C, the relative optical performance/characteristics of the display module (e.g. contrast, dynamic range, brightness/intensity, transmittance, distortion, lens effects, reflective effects, refraction, light pollution, overall image quality, etc.) may be determined by the selection of materials and construction/form of the display module. See also FIGS. 1D-1E and 4A-4F (e.g. schematically indicating optical performance of the display module).

As shown schematically according to an exemplary embodiment in FIGS. 8A and 8C, the display module 100 with filler/insert may comprise a multi-layer construction with materials selected in a manner intended to facilitate/optimize optical performance; as indicated schematically, the index of refraction Ai of the filler/insert 4 and the index of refraction Ac of the cover layer 1 may be substantially identical/matched (see FIG. 8A) or closely matched (see FIG. 8C). See also FIGS. 1D-1E, 3A-3B and 4A-4D (schematically indicating enhanced/intended optical performance). As shown schematically in FIG. 8B, the display module 200 with air gap may provide reduced optical performance as indicated by the mismatch of the index of refraction Aa of the air gap AG/24 and the index of refraction Ac of the cover layer 1. See also FIGS. 3C-3D and 4E-4F (schematically indicating reduced optical performance).

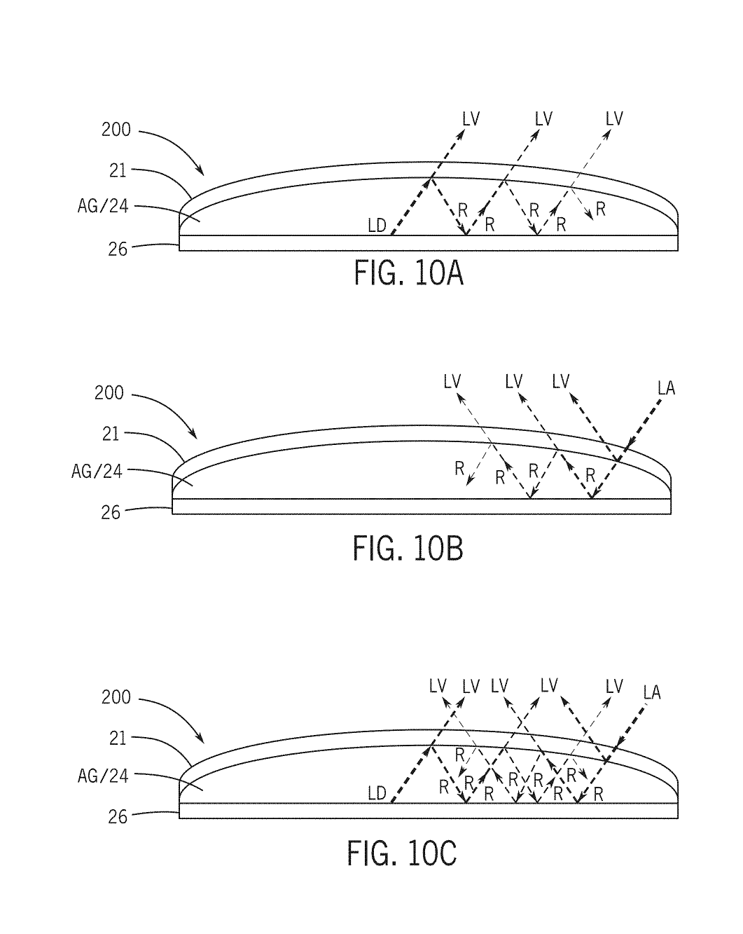

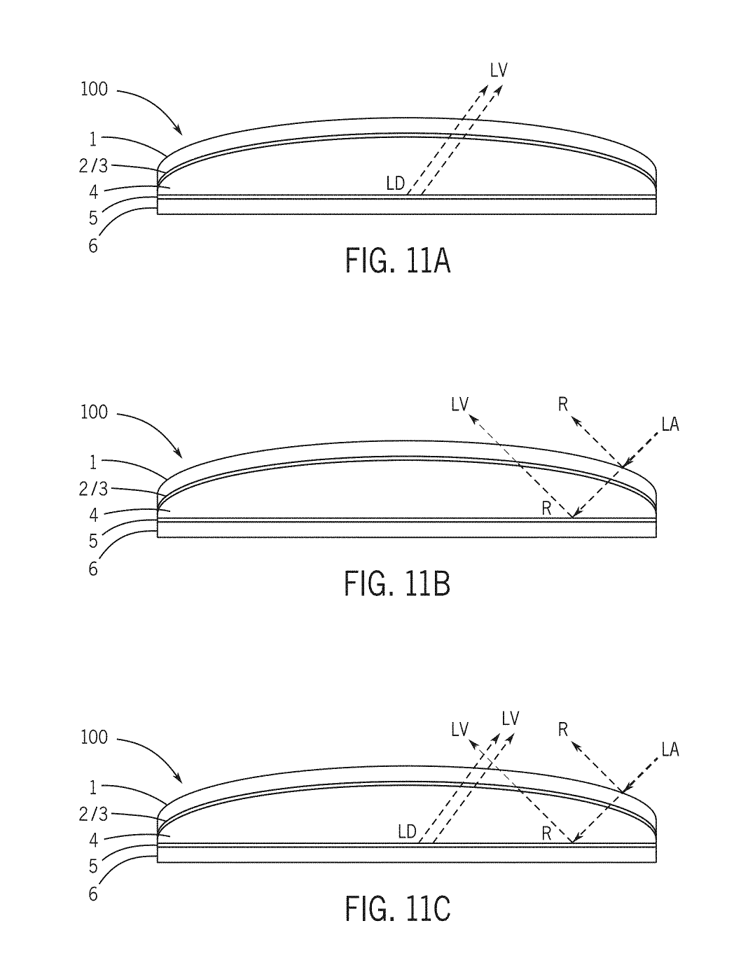

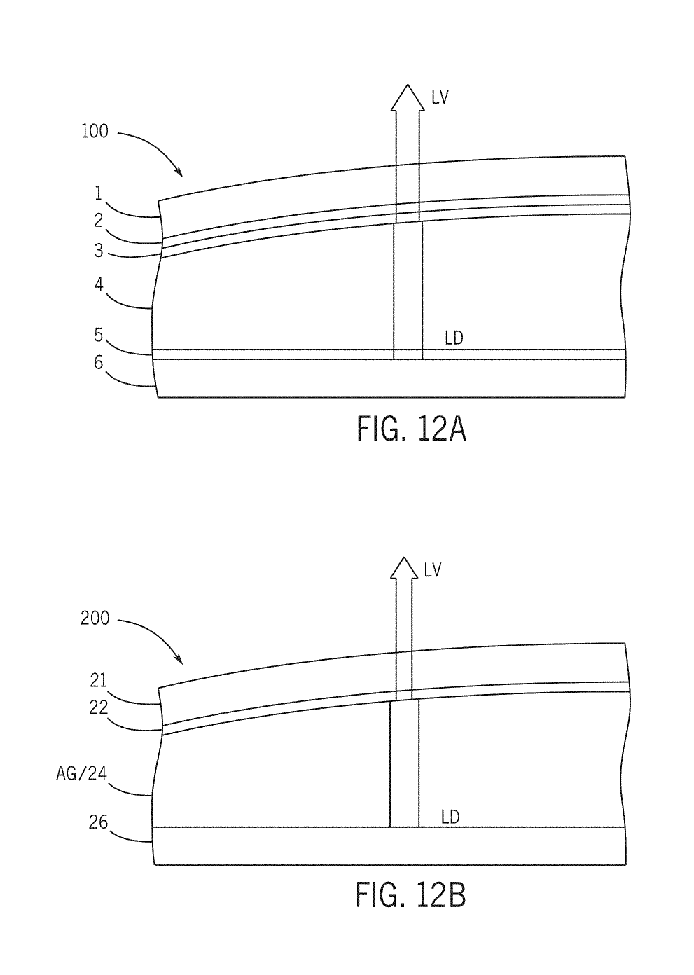

As shown schematically according to an exemplary embodiment in FIGS. 9A and 9C and 11A-11C, the display module 100 with filler/insert may comprise a multi-layer construction with materials selected in a manner intended to facilitate/optimize optical performance; as indicated schematically, light LD from the display panel 5 is transmitted through the adhesive/bond 5 and filler/insert 4 and adhesive/bond 3 and interface 2 through cover layer 1 with substantially no internal reflectance to become visible light LV (see FIGS. 9A and 11A) or with relatively insubstantial internal reflectance R to become visible light LV (see FIG. 9C); there is relatively insubstantial internal reflectance R of ambient light LA entering the display module 100 (see FIG. 11B) and relatively insubstantial interference of ambient light LA with light LD from the display panel as affecting the visible light LV. See also FIGS. 1D-1E, 3A-3B and 4A-4D (schematically indicating enhanced/intended optical performance). As shown schematically in FIGS. 9B and 10A-10C, the display module 200 with air gap AG/24 may provide reduced optical performance as indicated by relatively substantial internal reflectance R of light LD from the display layer 5 to visible light LV at the cover layer 1 (see FIGS. 9B and 10A) and by effect of ambient light LA entering the display module 200 to produce reflected light R within the display module (e.g. to a substantial degree) that will become visible light LV notwithstanding that the display panel is not providing any light (see FIG. 10B) or become visible light LV that will interfere with light LD from the display panel (see FIG. 10C). See also FIGS. 3C-3D and 4E-4F (schematically indicating reduced optical performance).

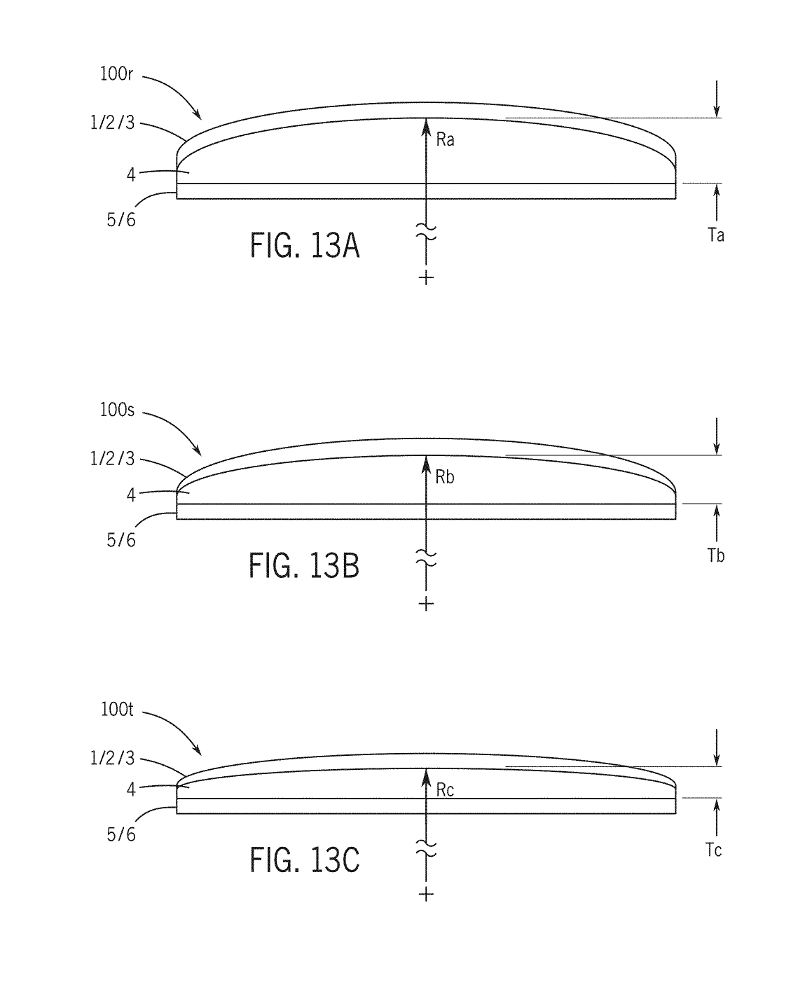

As indicated schematically in FIGS. 12A and 12B, the display module 100 with filler/insert may comprise a multi-layer construction with materials selected in a manner intended to facilitate/optimize optical performance for display module 100 (e.g. relatively greater net transmission of light LD from the display panel 5 through the cover 1 as visible light LV 5) in comparison with the display module 200 with air gap (e.g. relatively less net transmission of light LD from the display panel 25 through the cover 21 as visible light LV).

According to an exemplary embodiment as indicated in FIGURES and TABLE A, the display module 100 may be formed and constructed of a wide variety of materials selected and or combined as intended to facilitate desired performance for the component/assembly, including but not limited to Polycarbonate (PC), a poly-acrylic material such as Polymethyl methacrylate (PMMA), Polyethylene terephthalate (PET), glass, composite materials, blended materials, etc. According to an exemplary embodiment, materials available in an injection moldable grade and would be suitable for the manufacturing of the filler/insert; glass may be mechanically formed for the filler/insert (e.g. mechanically formed to the shape required); according to an exemplary embodiment, a suitable resin based material with a similar index of refraction to the glass may be used (e.g. to achieve a more cost-effective solution).

According to an exemplary embodiment, adhesive systems (e.g. optically clear adhesive materials) can be used and/or blended for use to form the component to achieve desired optical performance characteristics (e.g. to match the index of refraction); for example; an adhesive/bond material may be selected (e.g. or blended) to match a similar index of refraction match of the cover and filler/insert; according to an exemplary embodiment, if the cover material has an index of refraction of 1.4 and the filler/insert material has an index of refraction of 1.5, an adhesive may be selected/blended to provide an index of refraction of 1.4 (e.g. to match the cover) or 1.5 (e.g. to match the insert). As indicated, by generally matching index of refraction (e.g. by minimizing the differences between the index of refraction) of each material (e.g. for cover and for filler/insert and for adhesive layer), the reflections and stray light in the optical system can be minimized. See FIGS. 8A and 8C and 9B-9C and 11A-11C. See also TABLE A (for comparison with material selection note that air gap AG may be expected to provide an index of refraction of approximately 1).

According to an exemplary embodiment the adhesive layer may comprise a liquid adhesive or an adhesive film (e.g. sheet/layer, pressure-sensitive adhesive layer, etc.) applied to bond the insert to the cover (and to the display panel); according to an exemplary embodiment, the adhesive layer will be applied in a manner to prevent any air gap between the insert and the cover (or between the insert and the display panel). According to an exemplary embodiment, the adhesive material may be selected and/or blended to provide a desired optical performance (e.g. index of refraction, transparency, etc.); the adhesive material (e.g. liquid, blend, film, etc.) used to bond the insert to the cover may be different (e.g. in material, form, etc.) from the adhesive material used to bond the insert to the display panel (e.g. a liquid adhesive with an index of refraction to match the cover may be used to bond the cover to the insert and an adhesive film with an index of refraction to match the insert may be used to bond the insert to the display panel); the adhesive materials used to bond the insert to the cover and display panel may be similar (or identical) in composition/form (e.g. both liquid, both identical liquid, both film/tape, etc.). Certain materials (e.g. PET films that may be a biaxially-oriented polyethylene terephthalate material) may have a varying index of refraction depending on the angle the light waves enter the material (e.g. film layer); certain materials (such as PET material/film) may provide a very high transparency; certain materials may have variations of optical properties/effect with form (e.g. thickness, shape, etc.); certain material may be used as film in the multi-layer/laminate structure as typically used to create electrical circuits, decorative elements and tinting or filtering. See TABLE A.

According to an exemplary embodiment, similar and/or identical materials may be selected for the cover layer and the filler/insert (e.g. to match or substantially match index of refraction of each item). See also FIGS. 3A-3B and 8A and 8C and TABLE A.

According to an exemplary embodiment as indicated schematically in FIGS. 6A-6B and 14A-14J and TABLE A, an adhesive material applied to bond the layers of the display module (e.g. adhesive bond 3, 5) may comprise a liquid optically clear adhesive and/or a blend of optically clear adhesive with other adhesive (e.g. silicone-based adhesive, glue/bond material, etc.) applied to provide a complete/continuous seamless (e.g. no gap) bond of layers (e.g. cover/interface to filler/insert, display panel to filler/insert); an adhesive blend may be formulated/applied to bond layers without substantial shrinkage (e.g. thermal expansion/contraction), to fill a gap between layers that is relatively insubstantial in thickness (e.g. gap larger than 4-5 mm), etc. to provide an optically continuous/complete bond that provides suitable optical performance (e.g. index of refraction matching, optical clarity, etc. in addition to improved cost-effectiveness and mechanical/functional performance). See FIGS. 3A-3B and 6A-6B and TABLE A. As indicated schematically an adhesive blend may be formulated (e.g. from combination of commercially available materials such as optically clear adhesives and other adhesives/materials) to provide suitable optical/functional performance for use in a display module (e.g. matched to index of refraction of layers/materials including cover and filler/insert).

According to an exemplary embodiment as indicated schematically in FIGS. 2B, 3A-3B, 6A-6B and 14A-14J and TABLE A, the display module/assembly 100/D will comprise a set of layers (e.g. cover, adhesive/bond, filler/insert, adhesive bond) of materials that are selected to provide a substantial match of index of refraction (e.g. each layer/material with a close approximate index of refraction to the adjacent layer/material) and in which there is complete lamination/continuity with no gap (e.g. substantially no air gap, imperfections, spotting, holes, discontinuities, etc. between layers as indicated in FIGS. 14E and 14I) as to facilitate enhanced optical performance. See also FIGS. 1D-1E, 4A-4D, 8A, 9A and 11A-11C (e.g. schematically indicating contrast and transparency effects of selected/matched layer materials for display module).

As indicated schematically according to an exemplary embodiment in FIGS. 1C, 2A, 6A-6B and 8A, the display module/assembly 100/D may be constructed to function in effect as a unitary component (e.g. configured for installation/mounting in a vehicle interior, providing the form/shape intended for design/aesthetics, reliability/suitability for automotive environment, designed for efficient manufacture, overall cost-efficiency, etc.) intended to provide optical performance as indicated schematically in FIGS. 1D-1E, 3A-3B and 4A-4D (e.g. integration with display panel/layer as to provide contrast with darker/lighter areas of display, general optical performance/aesthetics, etc.).

As indicated schematically, the interface/layer (e.g. touch screen sensor, sensor layer, sensing foil, capacitive foil, capacitive layer, sensor grid, etc.) under the cover layer may be selected and configured to be bonded/integrated in the assembly/construction of the display module to facilitate function/performance of the user interface of the display module (e.g. electronic/electrical performance, mechanical performance, sensitivity, accuracy, calibration, etc.) in additional to facilitating optical performance of the display module; the overall multi-layer construction of the display module may be configured to provide optimized optical performance and mechanical/functional performance for a particular vehicle use or application (notwithstanding variations in thickness/construction or material selection of cover layer, adhesive bond, filler/insert, interface/layer, etc.). See also FIGS. 2A-2B, 7A-7B and 13A-13C (schematically indicating construction of display module with varying curvature and filler/insert layer thickness).

As indicated schematically according to an exemplary embodiment in FIGS. 1B and 1C, a vehicle interior may comprise one display module D/100 or multiple display modules D of one configuration or of multiple different configurations as a vehicle interior component (e.g. configured for a particular function/fit in the vehicle interior, by size/shape, by design/specification, by selection of materials, etc.). See also FIGS. 2A-2B, 6A-6B, 7A-7B and 13A-13B and TABLE A (example selection of materials for compatibility/matching layers of the display module). As indicated schematically according to an exemplary embodiment in FIGS. 1A-1C and 2A-2B, materials for the vehicle interior component comprising the display module (including for the display module) may be selected to fit various design criteria for the application (including but not limited to optical performance) in an automotive/vehicle. See also TABLE A.

According to an exemplary embodiment, the display module/assembly D/100 may be designed and constructed/assembled with form and material selection/combination based on specifications/requirements (including optical performance, mechanical performance, manufacturability, cost efficiency, etc.); for example, according to an exemplary embodiment, a module with a glass cover assembly and insert comprised of a material such as ZEONOR (e.g. materials with relatively superior transparency and matching index of refraction for cover/insert, see FIGS. 4A-4B and TABLE A) can be bonded (e.g. using a relatively high-grade adhesive material such as with a liquid optically clear adhesive or an adhesive film/pressure sensitive adhesive layer) to provide relatively superior optical performance (at relatively higher cost); according to an exemplary embodiment, a module with a cover and insert comprised of a material such as TRITAN (e.g. materials with good transparency and matching index of refraction for cover/insert, see FIGS. 4A-4C and TABLE A) can be bonded (e.g. using an adhesive material/blend with an optically clear adhesive or an adhesive film/pressure sensitive adhesive layer) to provide relatively good optical performance (at relatively intermediate cost); according to an exemplary embodiment, a module with a cover and insert comprised of a polycarbonate material (e.g. materials with acceptable transparency and matching index of refraction for cover/insert, see FIGS. 4C-4D and TABLE A) can be bonded (e.g. using an adhesive material/blend with an optically clear adhesive or an adhesive film/pressure sensitive adhesive layer) to provide acceptable optical performance (at relatively lower cost).

According to an exemplary embodiment as shown schematically in FIGS. 6C-6D, a treatment/coating TC may be applied to provide a transition layer of material with an index of refraction. As indicated schematically in FIGS. 6C-6D, when the index of refraction of the cover 1 and the index of refraction of the filler/insert 4 are not identically matched, the application of the treatment/coating TC may modify the index of refraction at the underside (e.g. inner surface) of the cover (FIG. 6C) and/or the top (e.g. outer surface) of the insert (FIG. 6D); according to an exemplary embodiment, the index of refraction of the treatment/coating material may be substantially between the index of refraction of the cover and the index refraction of the filler/insert (e.g. with an index of refraction of 1.6 for the cover and an index of refraction of 1.4 for the filler/insert, the treatment/coating material may be selected or formulated/blended with an index of refraction of 1.5 (splitting or substantially equally dividing the difference)). See also FIGS. 4A-4D and 9A. According to an exemplary embodiment shown schematically in FIG. 6C, a module 100m may be provided with cover 1 having an inner surface with a coating TC of a material providing an index of refraction substantially equivalent to the index of refraction of the filler/insert. See also TABLE A. According to an exemplary embodiment shown schematically in FIG. 6D, a module 100n may be provided with filler/insert 4 having an outer surface with a coating TC of a material providing an index of refraction substantially equivalent to the index of refraction of the cover. See also TABLE A. According to an exemplary embodiment, the treatment/coating may be applied using a dip coating, spin coating, spray coating, sputtering, or other application method at a suitable thickness (e.g. at a thickness of <1 mil); the coating material can be used (e.g. selected, blended, formulated, etc.) to provide a transition layer to match the index of refraction of the filler/insert or to match the index of refraction of the cover or to provide an index of refraction substantially between the index of refraction of the filler/insert and the index of refraction of the cover (e.g. substantially at the numerical mean/average or midpoint value). As indicated schematically according to an exemplary embodiment in FIGS. 6C-6D, the transition layer provided by the treatment/coating may be of a material selected or blended/formulated to provide an index of refraction (and other properties) to produce an intended optical performance in the display module as constructed. See also FIGS. 4A-4D.

According to an exemplary embodiment, the cover and filler/insert 4 may be formed or constructed as a generally monolithic module to provide the curved/contoured outer surface and configured to be coupled to the display panel to form a display module D. See FIGS. 1C and 2A.

According to an exemplary embodiment, the display module D is constructed to provided optical performance (e.g. index of refraction matching, transparency) suitable for the use as a display and suitable for the vehicle interior application (e.g. physical fit, function, compatibility, connectivity, aesthetics, etc.). See FIGS. 1A-1C.

TABLE A
MATERIAL PROPERTIES/OPTICAL CHARACTERISTICS

| ITEM/ | | INDEX OF | |
|---|---|---|---|
| COMPONENT | MATERIAL | REFRACTION | TRANSPARENCY |
| LAYER | (example/type or category) | (approximate) | (percent) |
| Cover and/or | MAKROLON - | 1.58 | 89 |
| Filler/Insert* | Polycarbonate | | |
| | ACRYLITE Resist AG - | 1.49 | 91 |
| | PMMA | | |
| | TOPAS (Cyclo Olefin | 1.53 | 91 |
| | Copolymer) | | |
| | ZEONOR (Cyclo Olefin | 1.53 | 92 |
| | Polymer) | | |
| | Glass | 1.52 to 1.62 | 91 |
| | Nylon GRILAMID TR 90 | 1.3 | 91 |
| | TRITAN -Co-Polyester | 1.58 | 90-91 |
| | TENITE -Cellulose Acetate | 1.47 | 90 |
| Adhesive | Optically Clear Adhesive | +/−1.4 to 1.6+ | Optically clear |
| (applied/fluid) | (Liquid) | | (by specification) |
| | Blended adhesive system | Formula/blended | Optically clear/blend |
| | | composition to | (rated/specified) |
| | | match cover/filler | |
| | | (as selected) | |
| Adhesive | Polycarbonate/PMMA blend | +/−1.4 | 90 |
| (film/sheet) | PET | 1.53 to 1.71 | ~85 |
| | Polycarbonate | 1.58 | 89 |
| | PMMA | 1.49 | 91 |

*According to an exemplary embodiment, similar and/or identical materials may be selected for the cover and the filler/insert (e.g. to match or substantially match index of refraction).
NOTE:
Index of refraction for air gap is approximately 1.0 (e.g. air gap with no filler/insert between display panel and cover layer/assembly).

### Exemplary Embodiments

As indicated schematically in FIGS. 1C and 2A, the display assembly/module D/100 may comprise a generally flat display screen with a generally curved cover. Referring to FIG. 2B, the display module may comprise a multiple layer configuration according to an exemplary embodiment. As shown schematically according to an exemplary embodiment, the display assembly/module may comprise a display screen 6 (e.g. with data/electronic connection to a system to provide data/information for display) with a cover 1 shown as providing a curved surface (see also FIG. 6A); the display module according to an exemplary embodiment may also comprise an insert 4 (shown schematically as an optical element or insert) in a set of layers between the display panel 6 and the cover 1. See FIGS. 6A and 6B. According to an exemplary embodiment, the display module may comprise a display panel 6 with a cover assembly 1234 providing cover 1 and layer 2, adhesive 3 and insert 4. See FIGS. 14E and 14H. As indicated, cover assembly is configured to be assembled onto the display panel 6 (with intermediate/interface layer 5).

As shown schematically in FIGS. 14A and 14B, the layer 2 may be assembled into a cover subassembly 12; as shown schematically the cover subassembly 12 may be attached to insert/filler 4 using an applied material such as agent or adhesive material 3 from a source shown as applicator P to form a cover assembly 1234 prepared to be attached to the display panel 6. See FIGS. 14C-14E. As indicated according to an exemplary embodiment, the adhesive material is generally transparent (e.g. clear, optically clear, etc.). See also TABLE A.

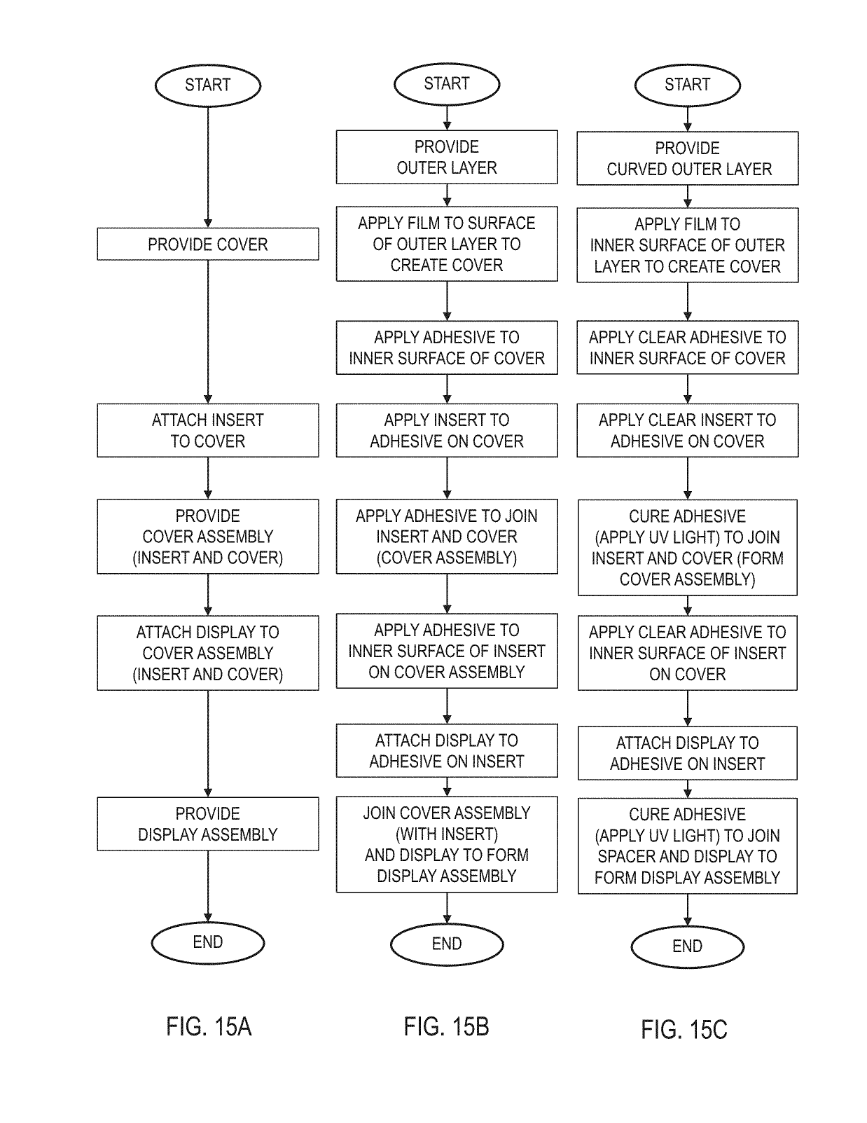

As shown schematically in FIGS. 14C-14E and 14F, the adhesive material 3 may be applied (and activated) to bond the cover subassembly 12 to the generally transparent/clear insert/filler 4; according to an exemplary embodiment, the material 3 may be activated during a curing step shown as by application of ultraviolet light from a source UV; cover assembly 1234 with insert 4 is prepared for attachment to the display panel 6. See also FIGS. 15A-15C (indicating methods of assembly according to an exemplary embodiment). As indicated schematically in FIGS. 14G and 14H, an adhesive material shown as an optically clear adhesive material 5 dispensed from a source shown as dispenser P may be used to attach or bond the cover assembly 1234 to the display panel 6; the adhesive material 5 may be activated to bond the cover subassembly 1234 to the display panel 6 to form the display assembly 123456. See also FIGS. 14I-14J and 15A-15C (indicating methods of assembly according to an exemplary embodiment).

Referring to FIGS. 2C and 10A-10C, a display assembly 200 of a generally conventional type (e.g. without the insert) is shown schematically. As indicated, light LD from display panel 26 is directed through a gap AG/24 toward the cover 21 (e.g. through layer 22) as visible light LV; as indicated a segment of the light LD from the display panel is lost as reflected light R (e.g. visible light LV is a subset of light LD from the display). As indicated schematically in FIG. 10C, ambient light LA (e.g. from the environment of the display assembly use) may be transmitted to the cover 21 and may reflect at the cover and/or be transmitted into the air gap AG/24 and onto the display panel 26 and reflected onto the inner surface of the cover assembly 21 (e.g. as reflected light R). See also FIGS. 10A and 10B (showing reflected light R from light LD from display panel 6 and from ambient light LA). As indicated schematically in FIGS. 9B and 10A-10C, with display module/assembly 200, reflected light R from the ambient light sources and from display panel may reflect from outside and from inside air gap AG/24 and will reduce the visibility (e.g. by reduced amplitude and interference) of visible light LV from the display. Compare FIGS. 3A-3B (improved relative optical performance of display module 100 with filler/insert/spacer) with FIGS. 3C-3D (reduced relative optical performance of display module 200 with air gap).

As shown schematically according to an exemplary embodiment in FIGS. 9A and 9C and 11A-11C, with display assembly/module 100 (e.g. providing an insert such as an optically transparent/clear filler/spacer), reflected light may be reduced such that the visible light is not substantially reduced from light LD from the display panel (notwithstanding effects on ambient light LA).

According to an exemplary embodiment, the arrangement/method of providing an insert in the display assembly as shown schematically is intended to eliminate the air gap and improves appearance of any image from the display. See e.g. FIGS. 14D-14E, 14F-14G and 15A-15C. According to an exemplary embodiment, the display assembly is intended to improve the appearance at the panel when the display screen is turned off (e.g. making the screen dark when “off”/not illuminated under the cover). See FIGS. 3A-3B and 4A-4D. According to an exemplary embodiment, a full contact bond between the solid insert/spacer and the cover (instead of filling the gap with adhesive) improves the strength and sound characteristics of the display assembly product. See FIGS. 2B and 14J. (As indicated the insert is an alternative to filling the gap completely with optically clear adhesive which may be cost prohibitive.)

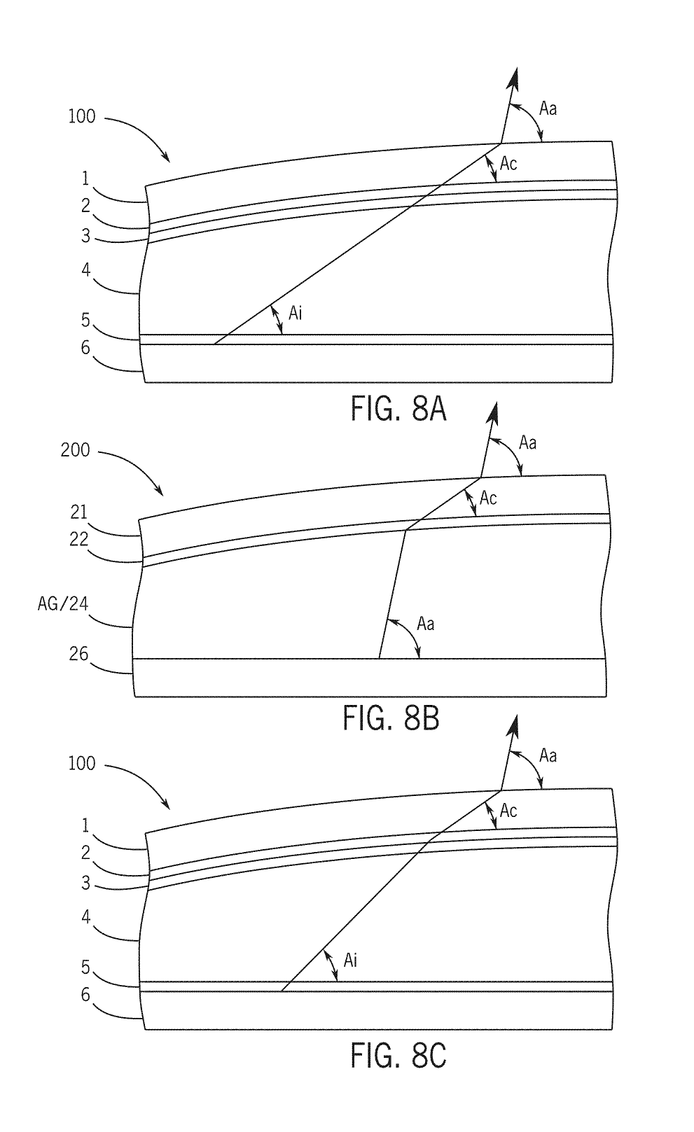

According to an exemplary embodiment shown schematically in FIGS. 1C and 2A-2B, the component for an interior of a vehicle with a display panel may be configured to provide a display providing light intended to be visible to an occupant in the vehicle when in operation after installation in the interior of the vehicle. See also FIGS. 1D-1E, 3A-3B and 4A-4D. According to an exemplary embodiment, the component may comprise a cover comprising an outer layer and an insert configured to be positioned between the display panel and the cover; the insert may be configured to allow light to pass from the display to the cover. See FIGS. 2B and 6A-6B. See also FIGS. 14A-14J. The display panel may comprise a flat surface; the cover may comprise an inner surface and an outer surface; the inner surface of the cover and the outer surface of the cover may be curved. See FIGS. 2B and 6A-6B. The insert may comprise a flat surface and a curved surface; the curved surface of the insert may be configured to align with the inner surface of the cover. The insert may be coupled to the cover and may be configured to reduce loss of light from the display panel by reflection between the display panel and the cover. The insert may comprise at least one of (a) a urethane material; (b) an acrylic material; (c) a polycarbonate material; (d) a substantially transparent material; (e) a plastic material. See also TABLE A. The component may comprise an adhesive configured to couple the insert to at least one of (a) the cover or (b) the display panel; the adhesive may be configured to transmit light from the display panel to the cover. See e.g. FIGS. 6A-6B, 9A and 14A-14J. The outer layer of the cover may comprise at least one of (a) glass or (b) plastic. See also TABLE A. The insert may comprise a spacer. The component may comprise a film on the cover; the film may comprise at least a material configured to transmit light from the display panel to the cover. See FIGS. 6A-6B, 7A-7B. The insert may be attached to the cover and to the display panel; the insert may be attached to the cover by an adhesive on the film; the insert may be transparent; the insert may be semi-transparent; the insert may comprise a lens. See e.g. FIGS. 2A-2B, 3B, 8A-8B and 10A-10B.

The present invention also relates to a display assembly for an interior of a vehicle with a display panel configured to provide a display providing light intended to be visible to an occupant in the vehicle when the display panel is in operation in the interior of the vehicle. The display assembly may comprise a cover comprising an outer layer and an insert between the display panel and the cover; the insert may be configured to allow light from the display to transmit from the display to the cover to reduce reflection of light between the display panel and the cover. See FIGS. 2A-2B, 3B, 8A-8B and 10A-10B. The display panel may comprise a flat surface; the cover may comprise an inner surface and an outer surface; the inner surface of the cover and the outer surface of the cover may be curved. The insert may comprise a flat surface and a curved surface; the curved surface of the insert may be configured to align with the inner surface of the cover. The flat surface of the display panel may be adjacent the flat surface of the insert; the insert may be coupled to the cover. The insert may comprise at least one of (a) a urethane material; (b) an acrylic material; (c) a polycarbonate material; (d) a substantially transparent material; (e) a plastic material. The display assembly may comprise an adhesive configured to couple the insert to at least one of (a) the cover or (b) the display panel. The adhesive may be configured to transmit light from the display panel to the cover. The outer layer of the cover may comprise at least one of (a) glass or (b) plastic. The display assembly may comprise a film on the cover; the film may comprise at least a material configured to transmit light from the display panel to the cover. The insert may be configured to facilitate transmission of light from the display panel to the cover; the insert may be attached to the cover and to the display panel; the insert may be attached to the cover by an adhesive on the film. The insert may be transparent; the insert may be semi-transparent; the insert may comprise a lens. See FIGS. 2A-2B, 3B, 8A-8B and 10A-10B. The display assembly may comprise a cover assembly comprising the cover and the insert; the cover assembly may comprise a film on the cover; the cover assembly may comprise an adhesive attaching the insert and the cover; the adhesive may be substantially transparent. See FIGS. 2A-2B, 3B, 8A-8B and 10A-10B.

According to an exemplary embodiment, the outer layer/cover may be made of glass or plastic; plastic outer layers may be made of vacuum formed acrylic or cast urethane. See FIGS. 2A-2B, 4A-4D and TABLE A. The layers may be clear or tinted (e.g. transparent rather than opaque). According to an exemplary embodiment, the outer layer/cover may have a contoured or curved surface for styling and harmony with other parts of the vehicle interior. See e.g. FIGS. 1C and 2A-2B. According to an exemplary embodiment, when the outer layer/cover is made of glass a clear or tinted film may be applied to the glass for safety; in the event of shattering or breaking of the glass, the applied film is intended to prevent fragments/shards of the glass from separating away; tinting the film may provide an improved appearance of the panel when the screen is turned off, making the screen harder to see under the cover; the film may be designed to provide decoration or to make certain areas of the outer layer opaque (e.g. blacked out). According to an exemplary embodiment, the film may be opaque in certain areas so as to prevent visibility of (e.g. mask) the edges of the display/screen.

According to an exemplary embodiment, any of a variety of multiple methods may be used to assemble the film and the outer layer to create a cover depending on the material used for the outer layer. See e.g. FIGS. 15A-15C.

When the outer layer is made of plastic methods of various types may be used in construction of the display assembly: in mold decoration; in mold lamination; printing coating/ink on the interior surface of the outer layer (or a portion of the layer); spraying coating/ink on the interior surface of the outer layer or on a portion of the layer, etc.; according to an exemplary embodiment, a film may be applied/adhered to the inner surface of the glass using pressure (e.g. with a bladder that is used to push any air gaps between the film and the glass to the periphery of the film and ultimately away from the film and the glass).

According to an exemplary embodiment, materials of various types may be used in construction of the clear spacer: cast urethane, machined acrylic (that may also be polished), injection molded acrylic, injection molded urethane, polycarbonate. See also FIGS. 2A-2B and TABLE A.

According to an exemplary embodiment, an optically clear (e.g. transparent) adhesive may be used to assemble the spacer to the cover. The adhesive may be a liquid that is applied in discrete amounts in multiple locations by a dispenser such as an automated syringe to the cover and/or the insert/spacer. The amount of adhesive and pattern of application may be selected so as to provide sufficient adhesive to create/establish for a full contact bond between the spacer and the cover (e.g. without waste or excessive adhesive); pressing together of the cover and spacer with adhesive in between forces the adhesive to flow to the edges of the spacer. See e.g. FIGS. 14A-14J and TABLE A. A cured adhesive may be used (e.g. cured by application of ultraviolet/UV light). See FIGS. 14A-14J and 15A-15C. After the spacer and cover are pressed together UV light may be used to cure the adhesive and securely (e.g. permanently) bond the cover and the spacer. (If a UV cured adhesive is to be used, the insert/spacer may be made of other than a polycarbonate material or other materials known to block UV light.)

According to an exemplary embodiment, an optically clear adhesive may be used to assemble the spacer/cover subassembly to the display. See FIGS. 2B and 14A-14J and TABLE A.

According to an exemplary embodiment, a component for an interior of a vehicle with a display panel configured to provide a display providing light intended to be visible to an occupant in the vehicle when in operation after installation in the interior of the vehicle may comprise a cover comprising an outer layer and an insert configured to be positioned between the display panel and the cover; the insert may be configured to allow light to pass from the display to the cover. The display panel may comprise a flat surface; the cover may comprise an inner surface and an outer surface; the inner surface of the cover and the outer surface of the cover may be curved. The insert may comprise a flat surface and a curved surface; the curved surface of the insert may be configured to align with the inner surface of the cover. The insert may be coupled to the cover and may be configured to reduce loss of light from the display panel by reflection between the display panel and the cover. The insert may comprise at least one of (a) a urethane material; (b) an acrylic material; (c) a polycarbonate material; (d) a substantially transparent material; (e) a plastic material. The component may comprise an adhesive configured to couple the insert to at least one of (a) the cover or (b) the display panel; the adhesive may be configured to transmit light from the display panel to the cover. The outer layer of the cover may comprise at least one of (a) glass or (b) plastic. The insert may comprise a spacer. The component may comprise a film on the cover; the film may comprise at least a material configured to transmit light from the display panel to the cover. The insert may be attached to the cover and to the display panel. The insert may be attached to the cover by an adhesive on the film; the insert may be transparent; the insert may be semi-transparent; the insert may comprise a lens.

According to an exemplary embodiment a display assembly for an interior of a vehicle with a display panel configured to provide a display providing light intended to be visible to an occupant in the vehicle when the display panel is in operation in the interior of the vehicle may comprise a cover comprising an outer layer and an insert between the display panel and the cover; the insert may be configured to allow light from the display to transmit from the display to the cover to reduce reflection of light between the display panel and the cover. The display panel may comprise a flat surface; the cover may comprise an inner surface and an outer surface; the inner surface of the cover and the outer surface of the cover may be curved. The insert may comprise a flat surface and a curved surface; the curved surface of the insert may be configured to align with the inner surface of the cover. The flat surface of the display panel may be adjacent the flat surface of the insert; the insert may be coupled to the cover. The insert may comprise at least one of (a) a urethane material; (b) an acrylic material; (c) a polycarbonate material; (d) a substantially transparent material; (e) a plastic material. The display assembly may comprise an adhesive configured to couple the insert to at least one of (a) the cover or (b) the display panel; the adhesive may be configured to transmit light from the display panel to the cover. The outer layer of the cover may comprise at least one of (a) glass or (b) plastic. The display assembly may comprise a film on the cover; the film may comprise at least a material configured to transmit light from the display panel to the cover. The insert may be configured to facilitate transmission of light from the display panel to the cover; the insert may be attached to the cover and to the display panel; the insert may be attached to the cover by an adhesive on the film. The insert may be transparent; the insert may be semi-transparent; the insert may comprise a lens. The display assembly may comprise a cover assembly comprising the cover and the insert; the cover assembly may comprise a film on the cover; the cover assembly may comprise an adhesive attaching the insert and the cover; the adhesive may be substantially transparent.

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for an interior of a vehicle with a display panel configured to provide a display providing light intended to be visible to an occupant in the vehicle when in operation after installation in the interior of the vehicle comprising:
(a) a cover comprising an outer surface;
(b) an insert configured to be positioned between the display panel and the cover;
wherein the insert is configured to allow light to pass from the display to the cover;
wherein the cover comprises a material and provides an index of refraction;
wherein the insert comprises a material and provides an index of refraction;
wherein the material of the insert is selected so that the index of refraction of the material of the insert substantially matches the index of refraction of the material of the cover;
wherein the cover and the insert comprise a module;
wherein the cover and the insert are configured to facilitate optical performance of the module;
wherein the insert is configured to limit reflection of light between the display panel and the cover.

2. The component of claim 1 wherein the cover comprises an inner surface and the outer surface; wherein the insert comprises an inner surface and an outer surface; and wherein the outer surface of the insert is configured to align with the inner surface of the cover.

3. The component of claim 1 wherein the cover comprises an inner surface and the outer surface; wherein the insert comprises an inner surface and an outer surface; and wherein the inner surface of the cover and the outer surface of the insert are contoured.

4. The component of claim 3 wherein the display panel comprises a generally flat surface; wherein the inner surface of the insert is generally flat and the outer surface of the insert is curved; wherein the inner surface of the cover is curved and the outer surface of the cover is curved.

5. The component of claim 1 wherein the material of the cover comprises at least one of (a) a urethane material; (b) an acrylic material; (c) a polycarbonate material; (d) a substantially transparent material; (e) a plastic material; (f) a resin material; (g) a glass material; (h) glass; (i) a nylon material; (j) a co-polyester material; (k) a cellulose acetate material; (l) a PET material; (m) a poly-acrylic material; (n) a polymer material;
wherein the material of the insert comprises at least one of (a) a urethane material; (b) an acrylic material; (c) a polycarbonate material; (d) a substantially transparent material; (e) a plastic material; (f) a resin material; (g) a glass material; (h) glass; (i) a nylon material; (j) a co-polyester material; (k) a cellulose acetate material; (l) a PET material; (m) a poly-acrylic material; (n) a polymer material.

6. The component of claim 1 wherein the index of refraction of the cover is between about 1.3 and about 1.6; and wherein the index of refraction of the insert is between about 1.3 and about 1.6.

7. The component of claim 1 wherein the insert is attached to the cover by an adhesive; wherein the adhesive comprises an index of refraction between an index of refraction for the material of the cover and an index of refraction for the material of the insert.

8. The component of claim 1 wherein the material of the cover comprises at least one of (a) glass and/or (b) plastic.

9. The component of claim 1 further comprising an interface between the cover and the display panel; wherein the interface comprises at least one of (a) a sensor; (b) a touch-screen interface; (c) a sensor grid; (d) a touch screen grid.

10. A display assembly for an interior of a vehicle comprising:
(a) a cover comprising an inner surface and an outer surface;
(b) an insert comprising an inner surface and an outer surface;
(c) a display panel configured to provide a display providing light;
wherein the inner surface of the cover is coupled to the outer surface of the insert;
wherein the inner surface of the insert is coupled to the display panel;
wherein the cover comprises a material providing an index of refraction;
wherein the insert comprises a material providing an index of refraction and is configured to allow light from the display to transmit from the display panel to the cover;
wherein the outer surface of the cover comprises a contoured surface;
wherein the inner surface of the cover and the outer surface of the insert are configured to align.

11. The display assembly of claim 10 wherein the index of refraction of the material of the insert is substantially equivalent to the index of refraction of the material of the cover.

12. The display assembly of claim 10 further comprising an adhesive configured to attach the insert to the cover; wherein the adhesive comprises a material providing an index of refraction substantially equivalent to at least one of (a) the index of refraction of the material of the insert; (b) the index of refraction of the material of the cover.

13. The display assembly of claim 12 wherein the adhesive comprises a material selected to provide an index of refraction substantially equivalent to the index of refraction of the material of the insert and the index of refraction of the material of the cover.

14. The display assembly of claim 12 wherein the adhesive comprises at least one of (a) a PET material; (b) a PMMA material; (c) a polycarbonate material; (d) a polymer blend material; (e) a polycarbonate/PMMA blend; (f) a poly-acrylic material; (g) a film; (h) an optically clear adhesive.

15. The display assembly of claim 10 wherein the display panel comprises a flat surface.

16. A module for an interior of a vehicle with a display panel configured to provide a display providing light intended to be visible to an occupant in the vehicle when the display panel is in operation in the interior of the vehicle comprising:
(a) a cover comprising a contoured outer surface;
(b) an insert between the display panel and the cover;
(c) an adhesive layer provided to bond the cover to the insert;
wherein the cover comprises a material providing an index of refraction;
wherein the insert comprises a material providing an index of refraction;
wherein the adhesive layer provided to bond the cover to the insert comprises a material providing an index of refraction;
wherein the index of refraction of the material of the cover is substantially equivalent to the index of refraction of the material of the insert.

17. The module of claim 16 wherein the adhesive comprises at least one of (a) an optically clear adhesive; (b) an adhesive blend; (c) a silicone-based adhesive; (d) a blend with an optically clear adhesive; (e) a liquid optically clear adhesive; (f) an applied adhesive; (g) a film adhesive; (h) a pressure-sensitive adhesive; (i) a pressure-sensitive adhesive film.

18. The module of claim 16 wherein the index of refraction of the material of the adhesive layer between the cover and the insert is substantially between the index of refraction of the material of the cover and the index of refraction of the material of the insert.

19. The module of claim 16 further comprising at least one of (a) a coating on an inner surface of the cover providing an index of refraction substantially between the index of refraction of the material of the insert and the index of refraction of the material of the cover; (b) a coating on an outer surface of the insert providing an index of refraction substantially between the index of refraction of the material of the insert and the index of refraction of the material of the cover; (c) a coating on an inner surface of the cover providing an index of refraction substantially equivalent to the index of refraction of the insert; (d) a coating on an outer surface of the insert providing an index of refraction substantially equivalent to the index of refraction of the cover.

20. The module of claim 16 wherein the index of refraction of the material of the cover is between about 1.3 and about 1.6; wherein the index of refraction of the material of the insert is between about 1.3 and about 1.6; wherein the index of refraction of the material of the adhesive layer is between about 1.4 and about 1.7.
